(19) United States
(12) Patent Application Publication
(10) Pub. No.: US 2016/0371405 A1
(43) Pub. Date: Dec. 22, 2016

(54) Systems and Methods of Forecasting Power Plant Performance

(71) Applicant: General Electric Company, Schenectady, NY (US)

(72) Inventors: Christopher Michael Raczynski, Atlanta, GA (US); Achalesh Kumar Pandey, San Ramon, CA (US)

(21) Appl. No.: 14/744,291

(22) Filed: Jun. 19, 2015

(51) Int. Cl. G06F 17/50; G06N 3/08

(52) U.S. Cl. CPC G06F 17/5009; G06N 3/08

(57) ABSTRACT

Embodiments of the disclosure relate to systems and methods of forecasting power plant performance. In one embodiment, a system can include a computer that is configured to use a calibrated physics-based simulation model to generate training data. The training data is used by the computer to effectuate a surrogate neural network model. Furthermore, the computer is configured to receive a periodic performance index. The periodic performance index, which is indicative of dynamic changes in one or more operating parameters of the power plant, is processed in combination with the surrogate neural network model by the computer for forecasting one or more performance parameters of the power plant.

### FIELD OF THE DISCLOSURE

This disclosure relates to power generation, and more particularly, to systems and methods of forecasting power plant performance.

### BACKGROUND OF THE DISCLOSURE

Energy traders typically carry out bidding in the marketplace based on power consumption forecasts and the corresponding power generation forecasts. These forecasts can consider a number of different factors, some of which are variable in nature. Among these variable factors can be the predicted performance efficiency of one or more power plants over a future period of time and the effects of weather on these power plants during this future period of time. In many traditional situations, the amount of power that is bid into the market for a power plant (and the associated fuel consumption to operate the power plant) is based on the intuition and experience of a plant manager. While this knowledge may have been built up by the plant manager after many years of service, there is also a natural tendency on the part of the plant manager to hedge his or her bets in order to avoid being caught short of fuel needs to operate the power plant. Unfortunately, erroneous forecasts based on such hedging can prove very expensive, because changing the amount of power generation of a power plant by even a few additional megawatts per hour can add up to a significant unrealized profit to the owner of the power plant.

Even where human forecasts are eliminated so as to avoid issues such as hedging, many alternative traditional forecasts based on computer-based solutions are also susceptible to errors, at least some of which may be attributable to inadequate modeling procedures and/or inaccurate assumptions.

A power generation plant typically includes a number of complex machines such as for example, a turbine, a compressor, a combustor, and a controller. Each of these complex machines can include a large number of stationary as well as moving parts. Some of these moving parts deteriorate upon prolonged usage. As a result, the amount of power generated by the power plant can deteriorate over time. Such deterioration can be addressed by replacing working parts that have suffered an unacceptable level of wear and tear, and/or by replacing defective parts that have become unsuitable for use. In some situations even after replacement of such faulty parts, the level of power generated by the power plant can be less than optimal, especially when compared to a level of power that was generated by the power plant at an earlier instant in time, say for example, when the power plant was first placed in service.

Unfortunately, comparing a level of performance of a power plant at any given instant in time against a level of performance of the power plant when the power plant is operated under optimal conditions is a complicated and difficult procedure due to a number of reasons. For example, it is often difficult to accurately characterize and quantify various operational parameters of the power plant especially when these operational parameters are constantly changing. The difficulty can not only be attributed to factors such as the complex interdependency between various structural components of the power plant, but also due to other factors such as the weather for example, which can play a significant role in terms of power generation and power consumption.

More specifically, it is often difficult to create an accurate reference model of a power plant that can be used to assess the performance of the power plant at any later instant in time after the power plant has been placed in service. In one traditional approach, power plant performance data is accumulated over a period of time, for example weeks, months or years. The accumulated “historic” data can be used to generate a “reference” power plant simulation model that is representative of an averaged approximation of the power plant over a variety of operating conditions over the period of time. However, it can be understood that various anomalies may have occurred during the period of time that the performance data was accumulated, especially when the period of time is very long (extending over several years, for example). These anomalies can result in the “reference” power plant simulation model being improperly skewed and not accurately reflecting the characteristics of the power plant, say for example, after some sub-optimal parts have been replaced recently.

The shortcoming in the time-averaged approach for collecting data may be addressed to some extent by generating a plant simulation model using data that is collected in real time. However, a plant simulation model based on real-time data collection suffers from certain shortcomings when this plant simulation model is used in a non-comparative stand-alone manner that does not take into consideration other types of information. For example, a plant simulation model based on real-time data may be used to evaluate a set of predictions or estimates provided by a human being. Such an evaluation may not only overlook the fact that the power plant may be operating sub-optimally when the real time data is collected, but also that the predictions and estimates provided by the human being have been historically unreliable and inaccurate.

### BRIEF DESCRIPTION OF THE DISCLOSURE

Embodiments of the disclosure are generally directed to systems and methods for forecasting power plant performance.

According to one example embodiment of the disclosure, a method can include providing in a computer system, a calibrated physics-based simulation model of a power plant. The calibrated physics-based simulation model is used to generate training data for effectuating a surrogate neural network model. Furthermore, a periodic performance index is received in the computer. The periodic performance index, which is indicative of dynamic changes in one or more operating parameters of the power plant, is processed in combination with the surrogate neural network model to forecast one or more performance parameters of the power plant.

According to another example embodiment of the disclosure, a system can include a computer that is configured to use a calibrated physics-based simulation model to generate training data. The training data is used by the computer to effectuate a surrogate neural network model. Furthermore, the computer is configured to receive a periodic performance index. The periodic performance index, which is indicative of dynamic changes in one or more operating parameters of the power plant, is processed in combination with the surrogate neural network model by the computer for forecasting one or more performance parameters of the power plant.

According to yet another example embodiment of the disclosure, a computer-readable storage medium can be provided. The computer-readable storage medium has stored thereon, instructions executable by a computer for performing operations that can include using a calibrated physics-based simulation model to generate training data. The training data is used to effectuate a surrogate neural network model. The surrogate neural network model is processed in combination with a periodic performance index, which is indicative of dynamic changes in one or more operating parameters of the power plant, to forecast one or more performance parameters of the power plant.

Other embodiments and aspects of the disclosure will become apparent from the following description taken in conjunction with the following drawings.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates an example power plant performance forecasting system associated with a power plant, according to one embodiment of the disclosure.

FIG. 2 illustrates some example components of the power plant forecasting system shown in FIG. 1.

FIG. 3 illustrates an example flowchart of a method for forecasting performance of a power plant according to one embodiment of the disclosure.

FIG. 4 illustrates an example computer incorporating a processor for executing a power plant forecasting system according to one embodiment of the disclosure.

### DETAILED DESCRIPTION OF THE DISCLOSURE

The disclosure now will be described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will satisfy applicable legal requirements. Like numbers refer to like elements throughout.

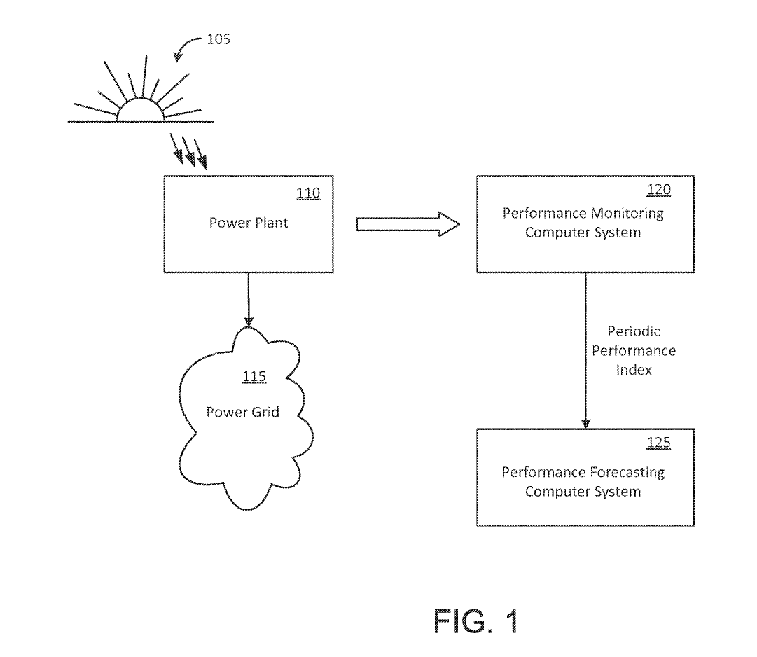

Turning to FIG. 1, an example power plant performance forecasting system 125 that is associated with a power plant 110 is illustrated, according to one embodiment of the disclosure. The power plant performance forecasting system 125 can be used to evaluate and forecast the performance of one or more of a number of complex power generating machines (not shown) that are used in the power plant 110 for generating power that is fed into the power grid 115. The performance of the power plant 110 at any given instant is influenced by a number of factors, some of which can be intrinsic to the power generating machines and some of which can be extrinsic to the power generating machines.

One example of an intrinsic factor that can affect the power generation by the power plant 110 is the structural condition of some parts of a power generating machine. For example, one or more fins of a turbine blade may have deteriorated over a period of time such that an amount of airflow through the turbine has reduced gradually over this period of time. The reduced airflow can cause a drop in the amount of generated power. Similarly, the quality of the fuel provided to operate a compressor may be poor at any one time and better at another time, thus resulting in a variance in the amount of power generated by using the compressor.

One example of an extrinsic factor that can influence the performance of the power plant 110 is indicated in FIG. 1 by the weather 105. For example, the power plant 110 may have to work harder during days when the weather 105 is unfavorably hot or unfavorably cold.

Such intrinsic and extrinsic factors can be taken into consideration for accurate forecasting of the performance of the power plant 110. Further, the performance of the power plant 110 can be monitored on an ongoing regular basis so as to obtain performance data that is up-to-date. This monitoring functionality may be carried out by the performance monitoring computer system 120. There are many different systems and methods that can be employed to execute the functionality of the performance monitoring computer system 120. In one exemplary implementation, plant data is obtained from the power plant 110 on the basis of a sampling routine having a desired level of periodicity. A few non-exhaustive list of repetitive sampling routines can include a first sampling routine referred to herein as a sub-hourly sampling routine where plant data samples are obtained at “x” minutes intervals every hour throughout each day, a second sampling routine that is an hourly sampling routine, a third sampling routine that is a daily sampling routine, a fourth sampling routine that is a weekly sampling routine, and a fifth sampling routine that is a monthly sampling routine.

The plant data samples obtained via one or more of these sampling routines are evaluated in the performance monitoring computer system 120 by using a computer simulation model of the power plant and the results of the evaluations are provided to the performance forecasting computer system 125. When the sampling routine is of the order of “x” minutes intervals throughout each day, or on a daily basis, for example, the evaluation results generated by the performance monitoring computer system 120 based on such recent historical data, provide a granular level of information that greatly exceeds the level of information derived by many traditional systems that employ historical data extending over much longer periods such as months or years. Understandably, using older historical data fails to provide accurate forecasting results as the power plant may not be at the same level of performance as when the data accumulation was begun. This problem is compounded if the forecasting does not use reference parameters associated with a power plant generating an optimal level of power at an earlier instant, such as when the power plant was first placed in service.

In the exemplary implementation shown in FIG. 1, the results of the evaluations by the performance monitoring computer system 120 can be provided to the performance forecasting computer system 125 in the form of a periodic performance index. The periodic performance index, which can also be referred to as a data match multiplier (DMM), can be formatted in various ways using various numerical values. In this exemplary implementation, the periodic performance index is provided to the performance forecasting computer system 125 in a format comprising a range of numerical values referenced to a normalized numerical value. The normalized numerical value can be set equal to 1 and the range of numerical values can encompass numerical values less than 1 and numerical values greater than 1. Each numerical value less than 1 can be indicative of a level of degradation of at least one physical attribute of the power plant 110 and each numerical value greater than 1 can be indicative of a level of improvement of one or more physical attributes of the power plant 110. In an alternative implementation, the normalized numerical value may be indicated using a numerical value other than 1, such as 10, for example, or can be represented in other numerical formats such as for example, a percentage value. Irrespective of the manner in which it is formatted, the normalized numerical value is indicative of an optimal performance of the power plant.

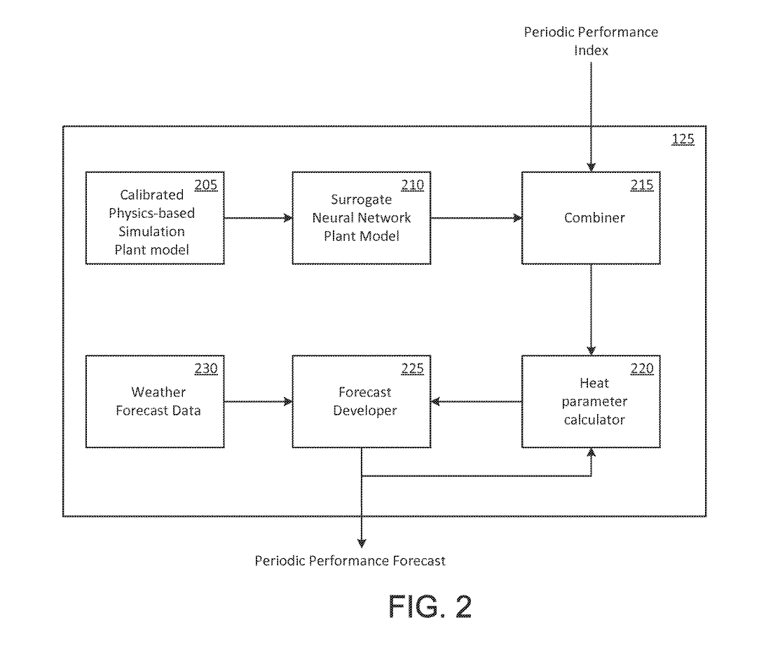

The performance forecasting computer system 125 uses the periodic performance index to forecast the performance of the power plant 110 as will be described in further detail using FIG. 2, which illustrates some example components of the power plant forecasting system 125. These example components can be implemented in hardware, software, firmware, or combinations thereof. The calibrated physics-based simulation plant model 205 represents a computer simulation model of the power plant 110 when the power plant 110 is operated in accordance with a calibrated set of specifications. The calibrated set of specifications can be, for example, a set of original equipment manufacturer (OEM) specifications that are provided by a manufacturer of the power plant 110 to a customer. The manufacturer may typically ensure that the power plant 110 is in conformance to the OEM specification when the power plant 110 is delivered and commissioned at the customer site. As such, the performance parameters of the power plant 110 at this point in time can represent a reference set of parameters (calibrated set of parameters) against which performance parameters of the power plant 110 at later instants in time (another day, week, month, or year for example) can be evaluated.

The calibrated physics-based simulation plant model 205 can be used to generate training data that is provided to a surrogate neural network plant model 210. As the name suggests, the surrogate neural network plant model 210 can be viewed as a surrogate representation of the power plant 110 by way of the calibrated physics-based simulation plant model 205. Various load parameters can be applied to the surrogate neural network plant model 210 in order to generate various evaluation plant models. Some or all of the various load parameters that are applied to the surrogate neural network plant model 210 can be different from the OEM-oriented load parameters applied to the calibrated physics-based simulation plant model 205. One or more of the evaluation plant models generated by the surrogate neural network plant model 210 can be used as one or more calibrated reference templates by the combiner 215.

The combiner 215 processes the calibrated reference templates in combination with the periodic performance index that is provided to the combiner 215 by the performance monitoring computer system 120 (shown in FIG. 1). The output of the combiner 215 is provided to a heat parameter calculator 220, which interactively operates with a forecast developer 225 to generate periodic performance forecasts. The forecast developer 225 receives a weather feed in the form of weather forecast data 230. Some examples of weather forecast data 230 include ambient temperature, pressure, and humidity at the power plant 110 for a period of time over which a periodic performance forecast is desired.

The operations carried out by the forecast developer 225 generally involve sweeps of various load fractions over each forecast period (for example, an hour-by-hour forecast). The sweeps can range from 50% to 100% of a base load placed upon the power plant 110. In one example implementation, the sweeps are directed at evaluating the effect of various loads upon the incremental heat rate (IHR) of the power plant 110.

The evaluation results can be provided in the form of an IHR curve, which is useful in making decisions to perform remedial action upon the power plant 110 if such remedial action is desired. IHR can be generally defined as an amount of fuel required to produce the next megawatt (MW) of output from the power plant 110 and has to be monotonically increasing in nature. Calculating an IHR can be carried out by minimizing a mean square error of the heat rate derived from the surrogate neural network plant model 210 and the heat rate derived from various points on a proposed IHR curve under the constraint that each IHR point be greater than the one before.

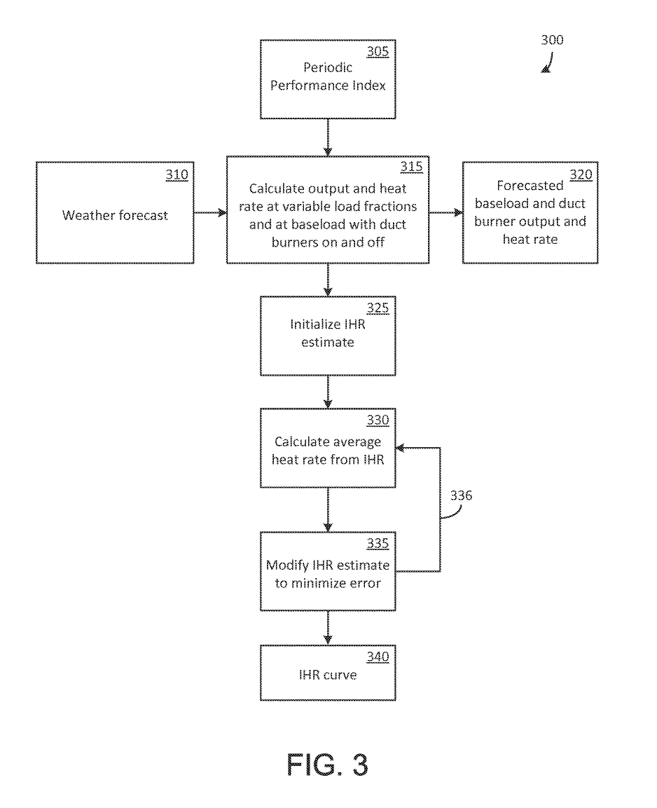

FIG. 3 illustrates an example flowchart 300 of a method for forecasting performance of a power plant according to one embodiment of the disclosure. The flowchart 300 represents a series of operations that can be executed by the interaction of the various functional blocks shown in FIG. 2. More particularly, the flowchart 300 includes a block 305 representing the periodic performance index described above. The periodic performance index is provided to calculation block 315. Also provided to the calculation block 315 is one or more weather forecast parameters (block 310). In the calculation block 315, these inputs can be used to calculate, for example, an output and heat rate at variable load fractions ranging from 0.6 to 1.0 and at a base load with duct burners on and off in the power plant 110. The output (block 320) from the calculation block 315 can include a forecasted base load, a duct burner output, and/or a heat rate. In block 325, an IHR estimate is initialized and used to calculate an average heat rate (block 330). The average heat rate is calculated using a recursive procedure by modifying the IHR estimate (block 335) in order to minimize an error between a calculated average heat rate and the actual heat rate. The action indicated in block 335 is carried out while maintaining increasing values of IHR. The resulting IHR curve (block 340) can be generated based on the recursive processing between the blocks 330 and 335 (the recursive processing is indicated by the arrow 336).

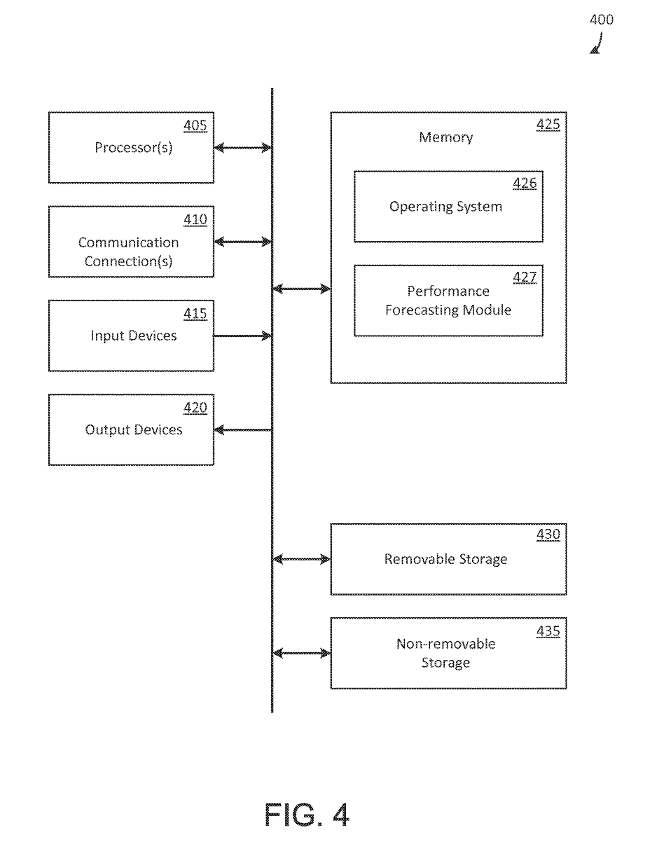

Attention is now drawn to FIG. 4, which illustrates an example computer 400 incorporating a processor 405 for executing a power plant forecasting system according to one embodiment of the disclosure. The processor 405 is capable of communicating with a memory 425. The processor 405 can be implemented and operated using appropriate hardware, software, firmware, or combinations thereof. Software or firmware implementations can include computer-executable or machine-executable instructions written in any suitable programming language to perform the various functions described. In one embodiment, instructions associated with a function block language can be stored in the memory 425 and executed by the processor 405.

The memory 425 can be used to store program instructions that are loadable and executable by the processor 405, as well as to store data generated during the execution of these programs. Depending on the configuration and type of the computer 400, the memory 425 can be volatile (such as random access memory (RAM)) and/or non-volatile (such as read-only memory (ROM), flash memory, etc.). In some embodiments, the memory devices can also include additional removable storage 430 and/or non-removable storage 435 including, but not limited to, magnetic storage, optical disks, and/or tape storage. The disk drives and their associated computer-readable media can provide non-volatile storage of computer-readable instructions, data structures, program modules, and other data for the devices. In some implementations, the memory 425 can include multiple different types of memory, such as static random access memory (SRAM), dynamic random access memory (DRAM), or ROM.

The memory 425, the removable storage 430, and the non-removable storage 435 are all examples of computer-readable storage media. For example, computer-readable storage media can include volatile and non-volatile, removable and non-removable media implemented in any method or technology for storage of information such as computer-readable instructions, data structures, program modules or other data. Additional types of computer storage media that can be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can be accessed by the devices. Combinations of any of the above should also be included within the scope of computer-readable media.

Computer 400 can also include one or more communication connections 410 that can allow a control device (not shown) to communicate with devices or equipment capable of communicating with the computer 400. The connections can be established via various data communication channels or ports, such as USB or COM ports to receive cables connecting the control device to various other devices on a network. In one embodiment, the control device can include Ethernet drivers that enable the control device to communicate with other devices on the network. According to various embodiments, communication connections 410 can be established via a wired and/or wireless connection on the network.

The computer 400 can also include one or more input devices 415, such as a keyboard, mouse, pen, voice input device, and touch input device. It can further include one or more output devices 420, such as a display, printer, and speakers.

In other embodiments, however, computer-readable communication media can include computer-readable instructions, program modules, or other data transmitted within a data signal, such as a carrier wave, or other transmission. As used herein, however, computer-readable storage media do not include computer-readable communication media.

Turning to the contents of the memory 425, the memory 425 can include, but is not limited to, an operating system (OS) 426 and one or more application programs or services for implementing the features and aspects disclosed herein. Such applications or services can include a performance forecasting module 427. In one embodiment, the performance forecasting module 427 can be implemented by software that is provided in configurable control block language and is stored in non-volatile memory. When executed by the processor 405, the performance forecasting module 427 implements the various functionalities and features described in this disclosure.

References are made herein to block diagrams of systems, methods, and computer program products according to example embodiments of the disclosure. It will be understood that at least some of the blocks of the block diagrams, and combinations of blocks in the block diagrams, respectively, can be implemented at least partially by computer program instructions. These computer program instructions can be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions can also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions can also be loaded onto a computer or other programmable data processing apparatus to cause a series of operational elements to be performed on the computer or other programmable apparatus to produce a computer implemented process such that the instructions that execute on the computer or other programmable apparatus provide elements for implementing the functions specified in the block or blocks.

One or more components of the systems and one or more elements of the methods described herein can be implemented through an application program running on an operating system of a computer. They also can be practiced with other computer system configurations, including hand-held devices, multiprocessor systems, microprocessor based, or programmable consumer electronics, mini-computers, mainframe computers, etc.

Application programs that are components of the systems and methods described herein can include routines, programs, components, data structures, etc. that implement certain abstract data types and perform certain tasks or actions. In a distributed computing environment, the application program (in whole or in part) can be located in local memory, or in other storage. In addition, or in the alternative, the application program (in whole or in part) can be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A method of forecasting performance of a power plant, the method comprising:
providing in a computer system, a calibrated physics-based simulation model of the power plant;
using the calibrated physics-based simulation model to generate training data in the computer system;
using the generated training data to effectuate a surrogate neural network plant model in the computer system;
receiving in the computer system, a periodic performance index that is indicative of dynamic changes in one or more operating parameters of the power plant; and
forecasting one or more performance parameters of the power plant by processing the surrogate neural network plant model in combination with the periodic performance index.

2. The method of claim 1, wherein the periodic performance index comprises a range of numerical values referenced to a normalized numerical value, the normalized numerical value indicative of a performance of the power plant in accordance with the calibrated physics-based simulation model.

3. The method of claim 2, wherein the normalized numerical value is equal to 1 and the range of numerical values encompasses numerical values less than 1 and numerical values greater than 1, each numerical value less than 1 being indicative of a level of degradation of at least one physical attribute of the power plant and each numerical value greater than 1 being indicative of a level of improvement of the at least one physical attribute or another physical attribute of the power plant.

4. The method of claim 2, wherein the periodic performance index is calculated on at least one of a sub-hourly basis, an hourly basis, a daily basis, or a weekly basis using one of a respective sub-hourly sampling routine, an hourly sampling routine, a daily sampling routine, or a weekly sampling routine.

5. The method of claim 2, wherein the surrogate neural network plant model is a variable load surrogate neural network plant model.

6. The method of claim 5, wherein the training data used to effectuate the variable load surrogate neural network plant model comprises variable load neural network training data.

7. The method of claim 5, further comprising:
calculating one or more heat related parameters of the power plant by applying the periodic performance index to the variable load surrogate neural network plant model.

8. The method of claim 7, further comprising:
combining weather forecast data with the one or more heat related parameters to forecast the one or more performance parameters of the power plant.

9. The method of claim 8, further comprising:
using a recursive procedure to update the forecast, the recursive procedure comprising updating the one or more heat related parameters on the basis of a periodic load increment.

10. A power plant performance forecasting system comprising:
a first computer configured to:
generate a periodic performance index that is indicative of dynamic changes in one or more operating parameters of a power plant;
a second computer communicatively coupled to the first computer, the second computer configured to:
use a calibrated physics-based simulation model to generate training data;
use the generated training data to effectuate a surrogate neural network plant model; and
forecast one or more performance parameters of the power plant by processing the surrogate neural network plant model in combination with the periodic performance index generated by the first computer.

11. The system of claim 10, wherein the first computer is the same as the second computer, and wherein the periodic performance index comprises a range of numerical values referenced to a normalized numerical value, the normalized numerical value indicative of the baseline performance of the power plant.

12. The system of claim 11, wherein the normalized numerical value is equal to 1 and the range of numerical values encompasses numerical values less than 1 and numerical values greater than 1, each numerical value less than 1 being indicative of a level of degradation of at least one physical attribute of the power plant and each numerical value greater than 1 being indicative of a level of improvement of the at least one physical attribute or another physical attribute of the power plant.

13. The system of claim 11, wherein the surrogate neural network plant model is a variable load surrogate neural network plant model.

14. The system of claim 13, wherein the training data used to effectuate the variable load surrogate neural network plant model comprises variable load neural network training data.

15. A computer-readable storage medium having stored thereon, instructions executable by a computer for performing operations comprising:
using a calibrated physics-based simulation model to generate training data;
using the generated training data to effectuate a surrogate neural network plant model; and
forecasting one or more performance parameters of the power plant by processing the surrogate neural network plant model in combination with a periodic performance index that is indicative of dynamic changes in one or more operating parameters of a power plant.

16. The computer-readable storage medium of claim 15, wherein the periodic performance index comprises a range of numerical values referenced to a normalized numerical value, the normalized numerical value indicative of the baseline performance of the power plant.

17. The computer-readable storage medium of claim 16, wherein the normalized numerical value is equal to 1 and the range of numerical values encompasses numerical values less than 1 and numerical values greater than 1, each numerical value less than 1 being indicative of a level of degradation of at least one physical attribute of the power plant and each numerical value greater than 1 being indicative of a level of improvement of the at least one physical attribute or another physical attribute of the power plant.

18. The computer-readable storage medium of claim 16, wherein the surrogate neural network plant model is a variable load surrogate neural network plant model.

19. The computer-readable storage medium of claim 18, wherein the training data used to effectuate the variable load surrogate neural network plant model comprises variable load neural network training data.

20. The computer-readable storage medium of claim 18, further comprising instructions for performing operations comprising:
calculating one or more heat related parameter of the power plant by applying the periodic performance index to the variable load surrogate neural network plant model; and
combining weather forecast data with the one or more heat related parameters to forecast the one or more performance parameters of the power plant.
